(19) United States
(12) Patent Application Publication
(10) Pub. No.: US 2003/0158802 A1
(43) Pub. Date: Aug. 21, 2003

(54) System and method for informing a recipient of a contribution of an investment gift

(75) Inventors: Veronica R. Houston, Midlothian, TX (US); Jerilyn A. Podany, Cedar Hill, TX (US)

Correspondence Address: Michael L. Diaz, Michael L. Diaz, P.C., Suite 200, 555 Republic Drive, Plano, TX, 75074, US

(73) Assignee: Morning Star Marketing, Inc.

(21) Appl. No.: 10/075,874

(22) Filed: Feb. 15, 2002

(51) Int. Cl. G06F 17/60

(52) U.S. Cl. 705/36; 705/35

(57) ABSTRACT

A method and system for informing a recipient of an investment gift. The system includes a financial institution providing investment plans to an investor. The system also includes an information provider providing messages to the financial institution for use in informing a recipient of an investment gift. The financial institution offers the messages to the investor providing an investment gift to a recipient. The message is sent by the investor to the recipient to inform the recipient of an investment gift. The system and associated method allows the financial institution to promote the sale of investment gifts and informs the recipient of the investment gift the details of the investment gift.

### BACKGROUND OF THE INVENTION

1. Technical Field of the Invention

This invention relates to conveying information on an investment and, more particularly, to a system and method for informing a recipient of an investment gift.

2. Description of Related Art

The conveyance of gifts from one person to another may take many different forms. In recent years, a popular type of gift is the investment gift. The investment gift enables a person to give a periodic or single monetary contribution to an investment plan, such as a mutual fund or shares of a particular stock, for a designated person. A primary advantage of this type of gift is that the monetary value of the investment gift normally increases over a length of time. An investment gift is particular effective for children. For example, it is quite common for a grandparent to contribute to an investment plan for their grandchild. The contribution typically increases in value over a period of time. After several years, the child may have a substantial amount of money within the investment plan. It is also quite common for the grandparent to periodically contribute additional amounts of money to the investment plan over the years to celebrate special occasions, such as holidays and birthdays.

However, when a person provides a gift to a recipient, there is no formalized and creative way of informing the recipient that money has been conveyed to the recipient in the form of an investment. The person giving the gift must either verbally inform the recipient of the gift or obtain a conventional card and add a handwritten comment informing the recipient of the investment gift.

In regards to contributing money to investment plans, it is quite common for a person to communicate with a financial institution, such as an investment firm having brokers, to obtain advice in determining the type of investment plan they wish to contribute. Oftentimes, investors make investment decisions bases on the information available at the actual financial institution's location or its associated web site. It is also well known that advertisements and added services specific to particular plans also increase contributions by investors to investment plans. Again, there is no system or method which may be used to inform an investor of the ability of giving an investment gift to a recipient and memorializing the investment gift for the recipient. It is logical that an investor, properly informed of the ability to give investment gifts, as well as providing a formalized method of informing the recipient of the gift, is more likely to contribute to such an gift investment plan.

Thus, it would be a distinct advantage to have a system and method which informs the investor of the ability to contribute an investment gift to a recipient and a formalized way of informing the recipient of the investment gift. It is an object of the present invention to provide such a system and method.

### SUMMARY OF THE INVENTION

In one aspect, the present invention is a system for informing a recipient of an investment gift. The system includes a financial institution offering an investment plan, a recipient receiving the investment plan, and an investor contributing to the investment plan for the recipient. In addition, the system includes an information provider providing a message to the recipient of the investor's contribution to the investment plan.

In another embodiment, the present invention is a method of informing a recipient of an investment gift from an investor. The method begins with an information provider providing a message to a financial institution offering an investment plan. Next, the investor communicates with the financial institution. The financial institution then offers an investment plan to the investor. The investor then selects an investment plan as a gift to the recipient. Next, the financial institution offers a message created by the information provider to the investor. The investor selects the message and sends the message to the recipient. The message indicates that an investment gift has been given to the recipient.

In another aspect, the present invention is a system for informing a recipient of an investment gift. The system includes a financial institution offering an investment gift plan, a recipient receiving the investment gift plan, and an investor contributing to the investment gift plan. The investor designates the recipient to receive the investment gift plan. An information provider provides a message to the financial institution. The financial institution offers a service of sending the message provided by the information provider to the recipient. The message informs the recipient of an investment gift given by the investor.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram illustrating the components of a system for informing a recipient of an investment gift in the preferred embodiment of the present invention;

FIG. 2 is a front perspective view of the card in the preferred embodiment of the present invention;

FIG. 3 is a front view of the interior portion of the card of FIG. 2;

FIGS. 4A and 4B are flow charts outlining the steps for informing the recipient of the receipt of an investment gift from the investor according to the teachings of the present invention;

FIG. 5 is a simplified block diagram illustrating the components of a system for informing a recipient of an investment gift in an alternate embodiment of the present invention;

FIG. 6 is a front view of an email message utilized in the system in an alternate embodiment of the present invention; and

FIGS. 7A and 7B are flow charts outlining the steps for informing the recipient of the receipt of an investment gift from the investor in an alternate embodiment of the present invention.

### DETAILED DESCRIPTION OF EMBODIMENTS

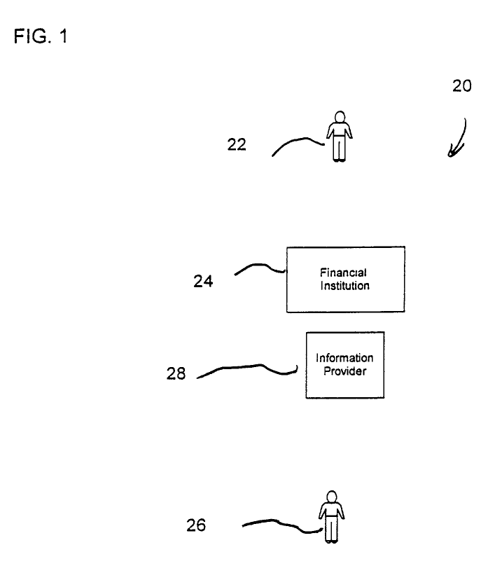

The present invention is a system and method for informing a recipient of a conveyance of an investment gift. FIG. 1 is a simplified block diagram illustrating the components of a system 20 for informing a recipient of an investment gift in the preferred embodiment of the present invention. The system includes at least one investor 22, a financial institution 24, a recipient 26 and an information provider 28. The investor is any person providing a monetary contribution to an investment plan provided by the financial institution 24. The financial institution may be any type of organization allowing the investor to contribute to an investment plan, such as a brokerage firm or a bank. The investment plan may include a purchase of one or more shares of a particular stock, the purchase of shares of a particular mutual fund, or the purchase of a specific commodity. Such investment plans may provide specific needs for the recipient, such as an Individual Retirement Account (IRA), an education fund, or other specialized fund.

The information provider provides a tangible memorialization of the investment gift to the financial institution 24. In the preferred embodiment of the present invention, the information provider creates a plurality of cards 30 indicating specific types of information. In an alternate embodiment of the present invention, a specialized gift may be utilized to memorialize the investment gift. For example, at a birth, a silver spoon may be used with a written text to celebrate the birth and inform the parents of the investment gift. In another example, a champagne glass may be given with information indicating the giving of an investment gift. The financial institution offers the plurality of cards to the investor. The investor may then select from the plurality of cards a specific card for the recipient. The card is then given to the recipient.

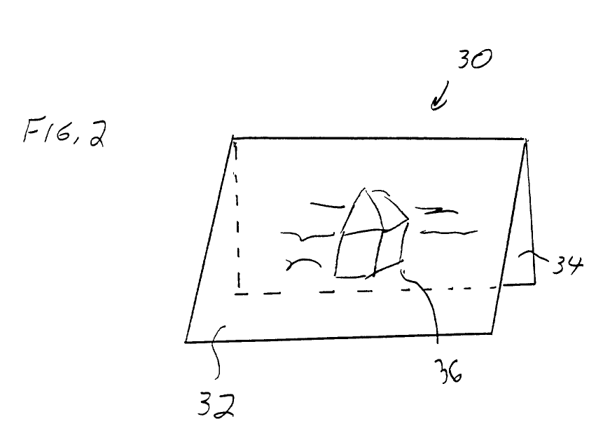

FIG. 2 is a front perspective view of the card 30 in the preferred embodiment of the present invention. The card 30 includes a frontal portion 32 and an interior portion 34. The frontal portion preferably includes an illustration such as a design, sketch, picture, or other artistic rendering 36. Additionally, the frontal portion may include an optional text (not shown) providing a verse, or specifying the purpose of the card.

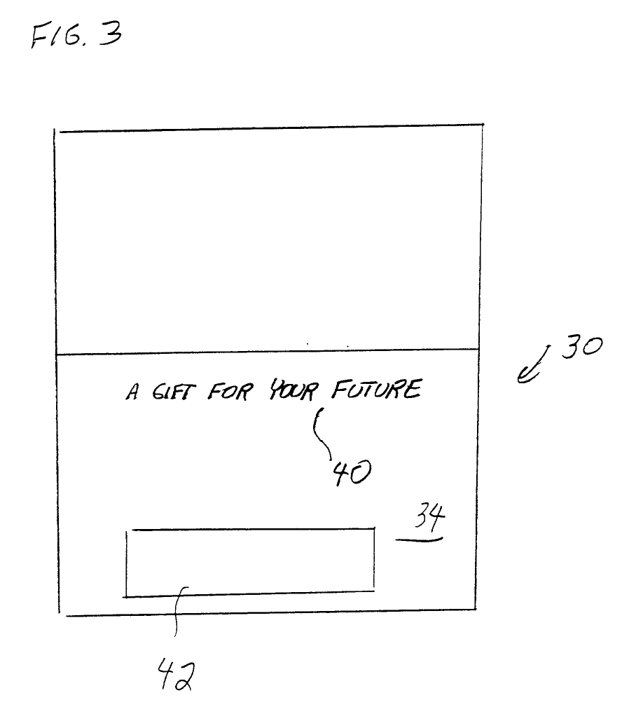

FIG. 3 is a front view of the interior portion 34 of the card 30 of FIG. 2. The interior portion may include an optional secondary text 40 and an optional blank area 42. For example, the text 40 may indicate, “a gift for your future.” The secondary text may include a specific verse or message appropriate for the occasion indicating that the investor is giving an investment gift. In addition, the secondary text may include an area indicating a specific amount and type of investment gift given to the recipient 26. The blank area allows the investor to add additional comments, writings, or signatures to personalize the card. Although the card is illustrated as a conventional holiday card having both text and illustrations, the card may be in any configuration allowing the transfer of information. The card may utilize any printing, embossing, painting, or any other process to visual display information on the card.

In utilizing the system 20, the investor interacts with the financial institution 24 to obtain information about investment opportunities available with the financial institution. The financial institution may provide information of the ability to convey investment gifts, either in a single lump sum contribution or through periodic contributions. The information provider provides a plurality of cards 30 to the financial institution. The financial institution may display the plurality of cards, providing an excellent marketing tool for enhancing the amount of contributions to investment plans offered by the financial institution. When the investor selects an investment plan offered by the financial institution as an investment gift, the financial institution provides the investor with an option of one or more cards 30. The investor then provides the selected card to the recipient, thus memorializing the investment gift. The card allows recipients to be informed that a contribution on their behalf has been made to an investment plan. The card simultaneously provides other information which the investor wishes the recipient to receive, such as congratulatory remarks on a special occasion. The card may optionally be sent directly by the financial institution to the recipient or his representatives.

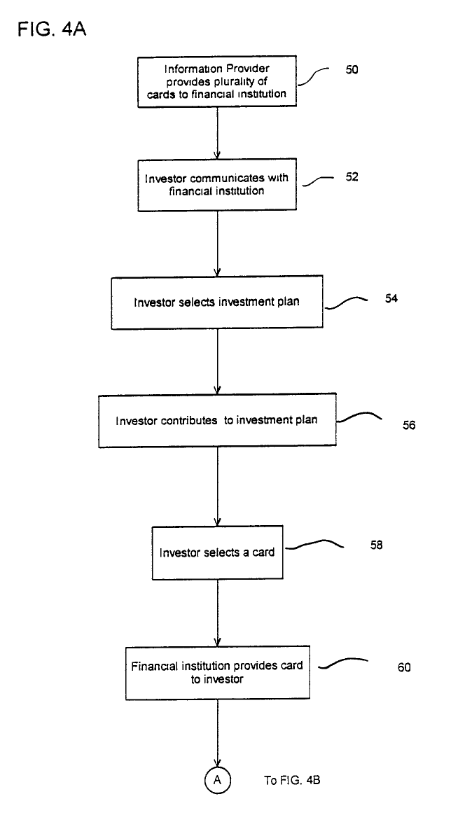

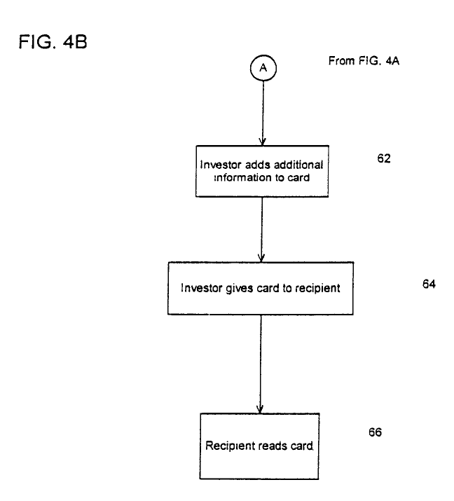

FIGS. 4A and 4B are flow charts outlining the steps for informing the recipient of the receipt of an investment gift from the investor 22 according to the teachings of the present invention. With reference to FIGS. 1-4, the steps of the method will now be explained. The method begins with step 50 where the information provider 28 provides a plurality of cards 30 to the financial institution 24. Each card may display a variety of text and illustrations which informs a recipient of the contribution of money to an investment plan. Next, in step 52, the investor 22 communicates with the financial institution. The financial institution may optionally inform the investor of an investment plan as a gift. In the preferred embodiment of the present invention, the financial institution displays the plurality of cards as a way to market the investment gifts to the investor. The method then moves to step 54, where the investor selects an investment plan offered by the financial institution as an investment gift. In step 56, the investor contributes to the selected investment plan. Then, in step 58, the investor may optionally select a card from the plurality of cards, to include a designated illustration and message. In an alternate embodiment of the present invention, a specialized gift may be given with information indicating that an investment gift has been given.

Next, in step 60, the financial institution 24 provides the investor 22 with a card memorializing the transaction. Next, in step 62, the investor may optionally include additional comments, illustrations, and signature within the blank area 42, personalized for the recipient. The method then moves to step 64 where the investor gives the card 30 to the recipient or recipient's representative (e.g., parent). Then, in step 66, the recipient reads the card, which informs the recipient of the investment gift by the investor 22 to the recipient.

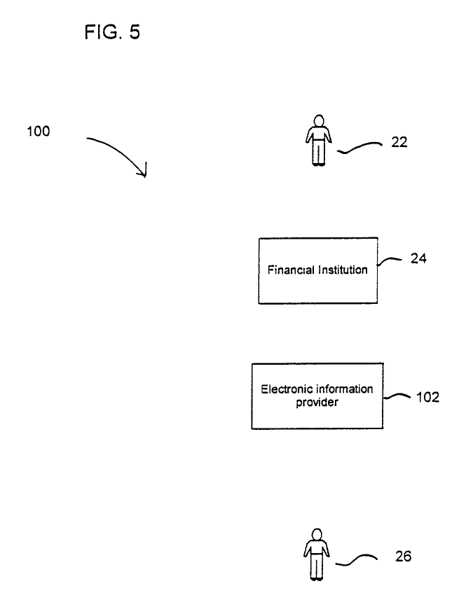

FIG. 5 is a simplified block diagram illustrating the components of a system 100 for informing a recipient of an investment gift in an alternate embodiment of the present invention. The system 100, in a similar fashion as in system 20, includes the investor 22, the financial institution 24 and recipient 26. The system 100, however, also includes an electronic information provider 102. The electronic information provider provides an electronic message for transfer by the financial institution or the investor to the recipient or his representatives. The electronic information provider may provide a wide variety of electronic gift message selections for transfer to the recipient. For example, the electronic messages may be email messages conveyed over the Internet to an email account associated with the recipient.

The electronic information provider may provide a wide selection of the electronic message to a web site maintained by the financial institution 24. Thus, when the investor 22 is visiting the financial institution's web site, the electronic gift messages may be displayed as options available to the investor. The display of the electronic gift messages may increase contributions by investors into the financial institution's investment plans by providing added value to the services offered by the financial institution.

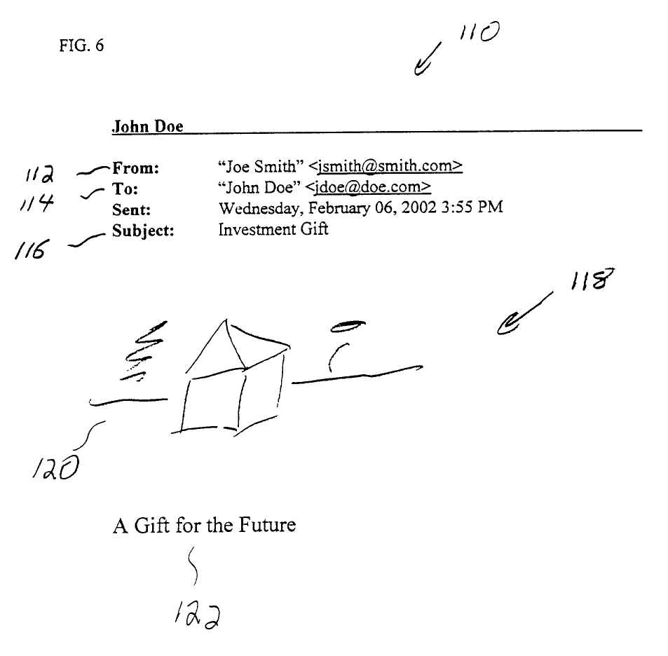

FIG. 6 is a front view of an email message 110 utilized in the system 100 in an alternate embodiment of the present invention. The email message 110 may include a sender address 112, a recipient address 114, a subject 116, and a message body 118. The message body may include an illustration 120 and a text message 122. The text message may include a verse or quotation. In addition, the text message may indicate information on the receipt of a contribution from the investor 22 to the recipient 26.

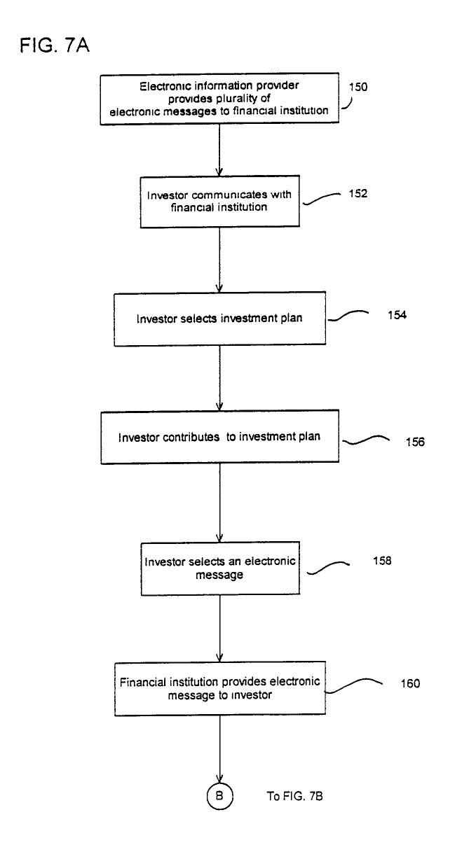

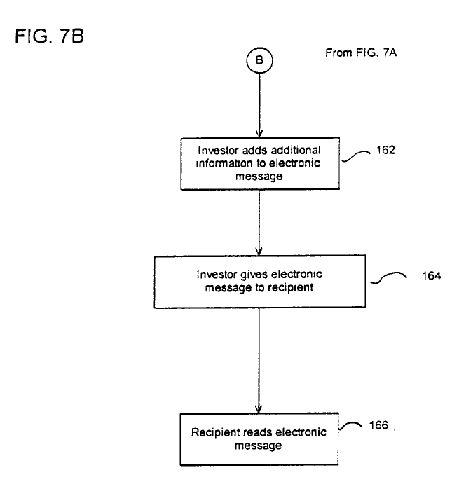

FIGS. 7A and 7B are flow charts outlining the steps for informing the recipient of the receipt of an investment gift from the investor 22 in an alternate embodiment of the present invention. With reference to FIGS. 5-7, the steps of the method will now be explained. The method begins with step 150 where the electronic information provider 102 provides a plurality of email messages 110 to the financial institution 24. Each message may display a variety of text and illustrations which informs a recipient of the contribution of money to an investment plan. Next, in step 152, the investor 22 communicates with the financial institution. The communications may include interaction with the financial institution's web site. At this time, the financial institution may optionally inform the investor of an investment plan as a gift. The financial institution may also display the plurality of email messages as a way to market the investment gifts to the investor. For example, the investor may be provided with a wide variety of choices of electronic messages. The method then moves to step 154, where the investor selects an investment plan offered by the financial institution as an investment gift. In step 156, the investor contributes to the selected investment plan. Next, in step 158, the investor optionally selects an electronic message format, style, text, and illustration.

Next, in step 160, the financial institution 24 provides the investor 22 with an email message 110 memorializing the transaction. Although an email message is illustrated, the electronic message may be transferred by any means, such as via facsimile, voice, video, etc. Next, in step 162, the investor may optionally include additional comments and an electronic signature personalized for the recipient. The method then moves to step 164 where the investor gives the message 110 to the recipient or recipient's representative (e.g., parent). Then, in step 166, the recipient reads the message which informs the recipient of the investment gift by the investor 22 to the recipient.

Although the information provider is illustrated as a separate entity from the financial institution, it should be understood that the information provider may reside with the financial institution. In addition, although one investor is discussed, a plurality of investors may utilize the disclosed invention. Additionally, although cards and email messages have been discussed, any item which conveys the information that an investment gift has been given may be employed.

The disclosed system and method provides many advantages over existing cards. The disclosed invention provides a specialized message format for presentation by representatives of the financial institutions to investors. Investors are shown these specialized messages unique for use with investment gifts, thus providing the option of contributing to an investment plan as a gift. By presenting the option to contribute to an investment gift plan, the financial institution increases overall contributions by the investors. Additionally, the financial institutions provide another unique service to the investor, the capability of informing recipients of the contributions made by the investors to a investment plan for the recipients. Thus, the occasion and gift are memorialized within the specially formatted message.

It is thus believed that the operation and construction of the present invention will be apparent from the foregoing description. While the method and system shown and described have been characterized as being preferred, it will be readily apparent that various changes and modifications could be made therein without departing from the scope of the invention as defined in the following claims.

What is claimed is:

1. A system for informing a recipient of an investment gift, said system comprising:
a financial institution offering an investment plan;
a recipient receiving the investment plan;
an investor contributing to the investment plan for said recipient; and
an information provider providing a message to said recipient of said investor's contribution to the investment plan.

2. The system of claim 1 wherein the message is a card.

3. The system of claim 1 wherein the message is an email message delivered via the Internet.

4. The system of claim 1 wherein the message is a voice message generated by said information provider.

5. The system of claim 1 wherein said information provider provides a plurality of messages, said investor selecting a message from said plurality of messages for delivery to said recipient.

6. The system of claim 1 wherein said message includes a textual message indicating that said recipient has been given an investment gift from said investor.

7. The system of claim 7 wherein said message includes an illustration.

8. The system of claim 1 wherein said message includes a blank area allowing said investor to transfer personalized information to said recipient.

9. The system of claim 1 wherein said information provider provides an electronic message via a web site for selection by said investor, said electronic message being delivered to said recipient from said financial institution to indicate that an investment gift has been given by said investor to said recipient.

10. The system of claim 1 wherein said information provider provides the message to the financial institution for distribution to the recipient.

11. The system of claim 1 wherein the message includes a specialized gift for said recipient.

12. A method of informing a recipient of an investment gift from an investor, said method comprising the steps of:
providing, by an information provider, a message to a financial institution offering an investment plan;
communicating, by the investor, with the financial institution;
offering, by the financial institution, an investment plan to the investor;
selecting, by the investor, the investment plan as a gift to the recipient;
offering a message created by the information provider to the investor;
selecting, by the investor, the message from the financial institution; and
sending the message to the recipient, said message indicating that an investment gift has been given to the recipient.

13. The method of claim 11 wherein said step of providing a message to the financial institution includes providing a plurality of messages to the financial institution.

14. The method of claim 12 wherein said step of selecting the message from the financial institution includes selecting a message from the plurality of messages from the financial institution.

15. The method of claim 11 wherein said step of providing a message to the financial institution includes providing an electronic message to the financial institution.

16. The method of claim 11 further comprising, after the step of selecting the message from the financial institution, the step of adding additional information to the message.

17. The method of claim 11 wherein the message is a card having an illustration and a textual message indicating that a investment gift has been given to the recipient.

18. The method of claim 11 further comprising, after the step of communicating by the investor with the financial institution, the step of displaying a message capable of being sent to a recipient of an investment gift.

19. A system for informing a recipient of an investment gift, said system comprising:
a financial institution offering an investment gift plan;
a recipient receiving the investment gift plan;
an investor contributing to the investment gift plan, said investor designating said recipient to receive the investment gift plan; and
an information provider providing a message to said financial institution;
whereby said financial institution offers a service of sending the message provided by said information provider to said recipient, the message informing said recipient of the investment gift being given by said investor.
